(19) United States
(12) Patent Application Publication
(10) Pub. No.: US 2007/0279161 A1
(43) Pub. Date: Dec. 6, 2007

(54) Method using a current to control a switch

(76) Inventor: Chen-Kai Lin, Magong City (TW)

Correspondence Address: Chen-Kai Lin, P.O. Box No. 6-57, Junghe, Taipei 235, omitted

(21) Appl. No.: 11/490,039

(22) Filed: Jul. 21, 2006

(30) Foreign Application Priority Data
May 30, 2006 (TW) 095119243

(51) Int. Cl. H01H 75/00

(52) U.S. Cl. 335/14

(57) ABSTRACT

The present invention provides a method using a current to control a switch, using a switch, comprising a first electrode and a second electrode, positioned within the magnetic range of a magnetic field produced by an electric current passing through a path, whereupon at least either the first electrode or the second electrode responds to the magnetism due to magnetic field variation, whereat the first electrode and the second electrode come in mutual contact or separate by means of the magnetic variation, thereby enabling controlling the switch.

### BACKGROUND OF THE INVENTION

(a) Field of the Invention

The present invention relates to a method using a current to control a switch, and more particularly to a method that uses a magnetic field produced by an electric current flowing in paths to cause a first electrode and a second electrode of a switch positioned within the magnetic field range to make mutual contact or separate due to magnetic variation, thereby controlling opening and closing of the switch.

(b) Description of the Prior Art

A power supply circuit of electrical related equipment, such as home appliances, overload protectors, electrical outlets, switches, extension cable plug sockets, plugs, computers, and so on, comprise at least a live wire and a neutral wire, and some power supply circuits even include an earth wire.

When using such electrical related equipment, an electric current must flow through the power supply circuit, and, according to Ampere's Law and Ampere's right hand rule, a current-carrying straight conducting wire produces a circumferential magnetic field, and the magnetic lines of force form closed concentric circles, moreover, directions of the magnetic field and the electric current are mutually perpendicular. Furthermore, strength of the magnetic field established is in direct proportion to size of the electric current in the conducting wire, and is in inverse proportion to distance between conducting wires. However, current methods using an electric current to produce a magnetic field to control a magnetic switch in proximity thereof, have apparently not been disclosed, particularly methods functioning with different forms of current paths to control a magnetic switch in proximity thereof have not been seen in pertinent literature.

### SUMMARY OF THE INVENTION

The present invention provides a method to control actuation of a switch, primarily using a magnetic field produced by an electric current flowing in a specific path to control a magnetizable switch.

The present invention further provides a method to control a circuit matching the switch according to actuation of the aforementioned switch.

A method using a current to control a switch of the present invention uses a switch, comprising a first electrode and a second electrode, positioned within the magnetic range of a magnetic field produced by an electric current passing through a path, whereupon at least either the first electrode or the second electrode responds to the magnetism due to magnetic field variation, whereat the first electrode and the second electrode come in mutual contact or separate by means of the magnetic variation, thereby enabling controlling the switch.

The aforementioned path is positioned to one side of the locality of the first electrode and the second electrode.

The aforementioned path partially surrounds the locality of the first electrode and the second electrode.

The aforementioned path encircles the locality of the first electrode and the second electrode, and encircling loops of the encircling section comprise at least one non-contacting encircling loop.

The aforementioned path comprises two paths respectively positioned at two sides of the locality of the first electrode and the second electrode, and direction of the electric current flowing in one of the side paths is opposite to that flowing in the other side path.

The aforementioned magnetic field variation indicates variation in the “strength and weakness” of the magnetic field or variation in the “present or absence” of the magnetic field.

Furthermore, the switch controlled by an electric current is further connected to a signal circuit able to produce a specific signal, and uses passing of an electric current to cause the specific signal circuit to produce a specific signal. The specific signal includes an optical signal, a sound signal, a packet signal transmitted by a computer network, a signal conforming to wireless communications protocol, a signal transmitted by a wired communications network, and so on.

The present invention is provided with the following characteristics:

1. The path enabling the flow of an electric current in the present invention can be formed with diverse path configurations, and each of the path configurations is able to produce a magnetic field of different strength to actuate the switch, thereby ensuring substantial control of the switch.

2. The present invention uses the magnetic field produced by an electric current to control a magnetic switch, and motive force actuating the switch is a magnetic force. Hence, actuation of the magnetic switch is “non-contact actuation”.

3. The magnetic field must attain a specific value before it is able to actuate the magnetic switch, and uses the principle of “the greater the electric current, the greater the magnetic field” such that when actuation of the fixedly positioned magnetic switch takes place, size of the working current at that time can be derived by backward inference. Hence, using such a principle, state of the working current can be known according to whether the magnetic switch has been actuated or not. Current load related current controlled devices can thus be developed, including current control methods, current caution devices, current caution methods, current display devices, current display methods, and so on.

4. Because errors may exist in the magnetism actuating the magnetic switch due to various manufacturing factors, thus, the present invention adjusts the distance between the magnetic switch and the current paths prior to disposition, and uses the principle of “the greater the distance, the smaller the magnetic field” to appropriately counteract the aforementioned errors in the actuating magnetism.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a schematic view of a first embodiment according to the present invention.

FIG. 2 shows a schematic view of the first embodiment according to the present invention, wherein a first electrode and a second electrode of a magnetic reed switch are in mutual contact.

FIG. 3 shows a schematic view of the first embodiment according to the present invention, wherein the first electrode and the second electrode of the magnetic reed switch are separated.

FIG. 4 shows a schematic view of a second embodiment according to the present invention, wherein the first electrode and the second electrode are partially surrounded by a path.

FIG. 5 shows a schematic view of a third embodiment according to the present invention, wherein the first electrode and the second electrode are encircled by at least one non-contacting loop of the path.

FIG. 6 shows a schematic view of a fourth embodiment according to the present invention, wherein the first electrode and the second electrode are positioned between two paths, and direction of the electric current passing through one of the paths is opposite to that passing through the other path.

FIG. 7 shows a schematic view of the present invention including an optical signal circuit in use in a power supply circuit.

FIG. 8 shows a schematic view of the present invention including a sound signal circuit in use in a power supply circuit.

### DETAILED DESCRIPTION OF THE PREFERRED EMBODIMENTS

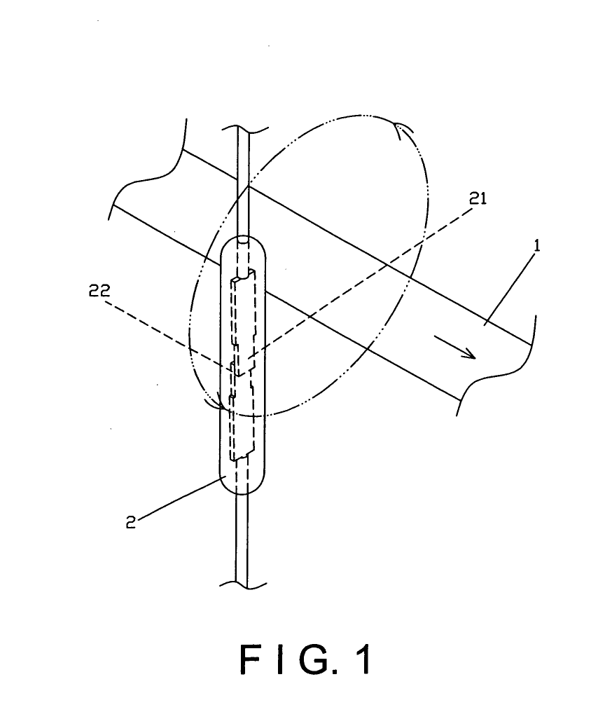

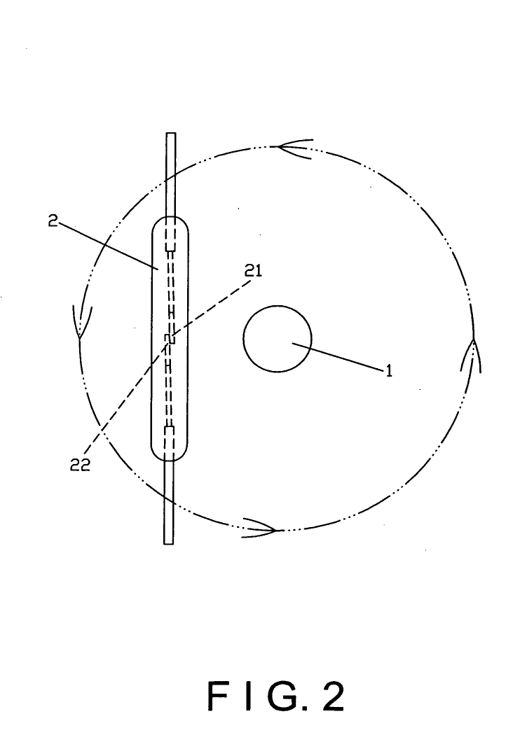

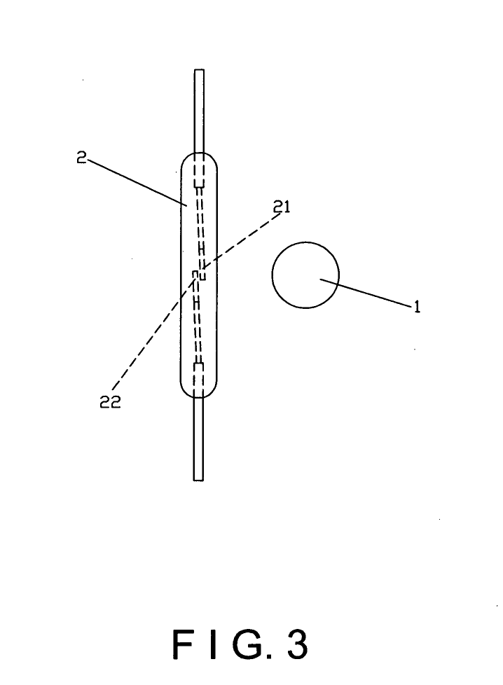

Referring to FIG. 1, which shows a method using a current to control a switch of the present invention, wherein an electric current flows through a path (1), and the straight arrowhead in FIG. 1 represents the direction of the electric current. The path (1) essentially can be a conductive metallic strip or metallic wire. A magnetic field is produced (the circular loop in FIG. 2) when the electric current passes through the path (1), and directions of the magnetic field and the electric current are mutually perpendicular. A magnetic reed switch (2), comprising a first electrode (21) and a second electrode (22), is positioned to one side of the path (1) and within the effective range of the aforementioned magnetic field, When strength of the magnetic field affecting the magnetic reed switch (2) is sufficiently large, opposite magnetic polarities are induced in overlapping areas of the first electrode (21) and the second electrode (22), thereby causing the first electrode (21) and the second electrode (22) to mutually attract and form a connection point, thus rendering the magnetic reed switch (2) in a conductive state (see FIG. 2). As soon as the strength of the magnetic field affecting the magnetic reed switch (2) dies out or weakens, then magnetism of the overlapping areas of the first electrode (21) and the second electrode (22) also dies out or weakens, whereupon the overlapping areas of the first electrode (21) and the second electrode (22) are no longer in contact, thus rendering the magnetic reed switch (2) in a non-conductive state (see FIG. 3).

When operating the present invention, an “oversized working current” produces a magnetic field of sufficient strength to effect the aforementioned actuation of the magnetic reed switch (2). Hence, actuation of the magnetic reed switch (2) can be used to produce a signal responding to the “oversized working current”.

A “from zero to non-zero working current” is also able to produce a magnetic field of sufficient strength to effect the aforementioned actuation of the magnetic reed switch (2). Hence, actuation of the magnetic reed switch (2) can be used to produce a signal responding to the “a working current exists”.

When “working current reaches a certain value”, this is also able to produce a magnetic field of sufficient strength to effect the aforementioned actuation of the magnetic reed switch (2). Hence, actuation of the magnetic reed switch (2) can be used to produce a signal responding to the “the working current has reached a certain value”.

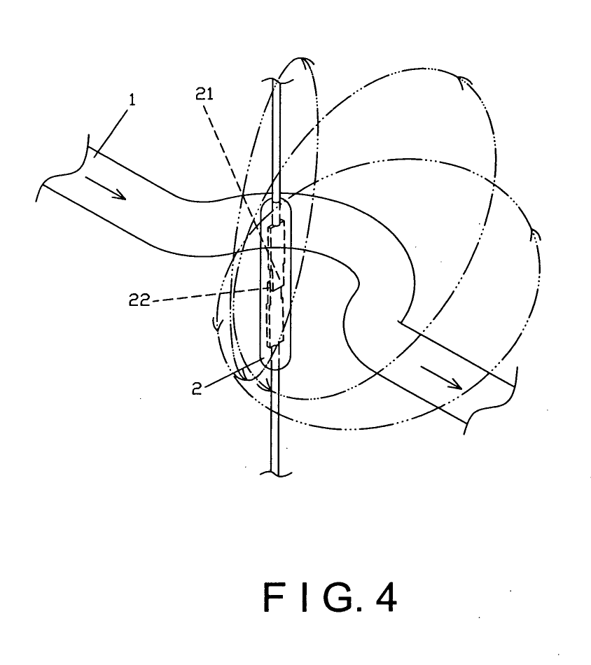

Referring to FIG. 4, wherein an electric current passes through the path (1), a section of which partially surrounds the locality of the first electrode (21) and the second electrode (22) of the magnetic reed switch (2), thereby providing a configuration with identical effectiveness, In such an embodiment, the magnetic reed switch (2) is positioned at the center of curvature of a curved section of the path (1), thus, the magnetic fields produced by the electric current passing through the curved section of the path (1) collectively effect the magnetic reed switch (2).

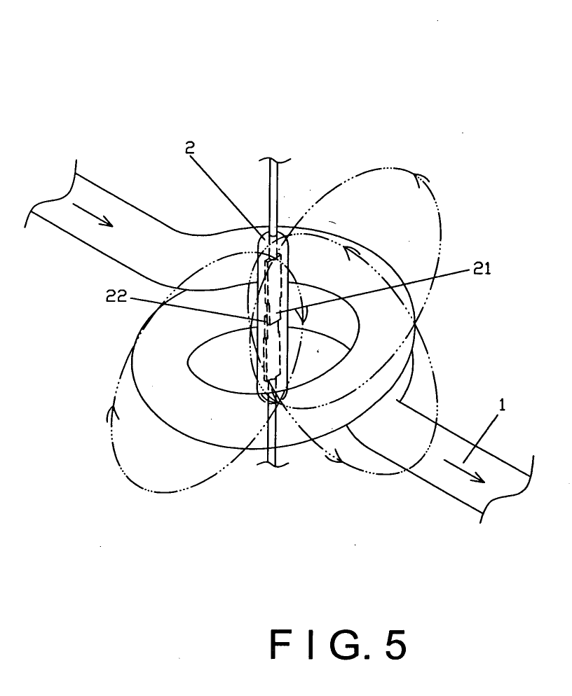

Referring to FIG. 5, wherein the path (1) itself encircles the locality of the first electrode (21) and the second electrode (22) of the magnetic reed switch (2), and the encircling section of the path (1) includes at least one non-contact encircling loop, thereby providing a configuration with identical effectiveness. Moreover, the more the number of encircling loops there are in the path (1), the greater the magnetic field produced.

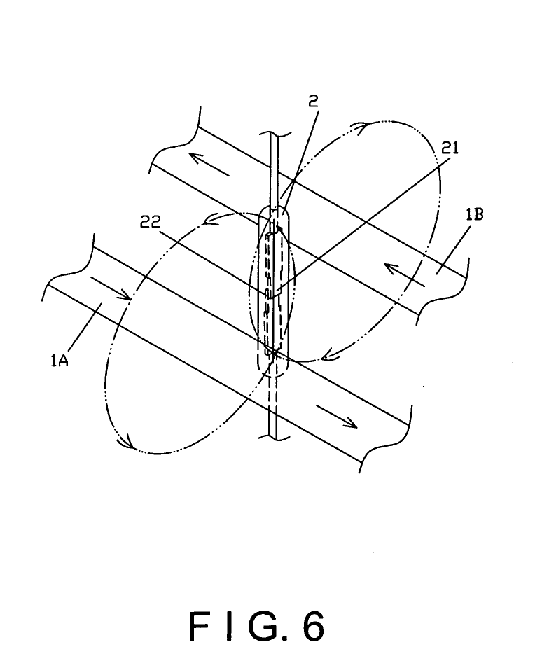

Referring to FIG. 6, wherein an electric current passes through a first path (1A) positioned to a first side of the locality of the first electrode (21) and the second electrode (22) of the magnetic reed switch (2), and another electric current passes through a second path (1B) positioned to a second side of the locality of the first electrode (21) and the second electrode (22) of the magnetic reed switch (2). Moreover, direction of the electric current flowing in the first path (1A) is opposite to direction of the electric current flowing in the second path (1B). Hence, the first path (1A) and the second path (1B) produce equidirectional magnetic fields at the locality of the first electrode (21) and the second electrode (22) of the magnetic reed switch (2), thereby forming an even greater magnetic force thereat. The aforementioned first path (1A) can be a live wire in a power supply circuit, and the second path (1B) can be a neutral wire in a power supply circuit.

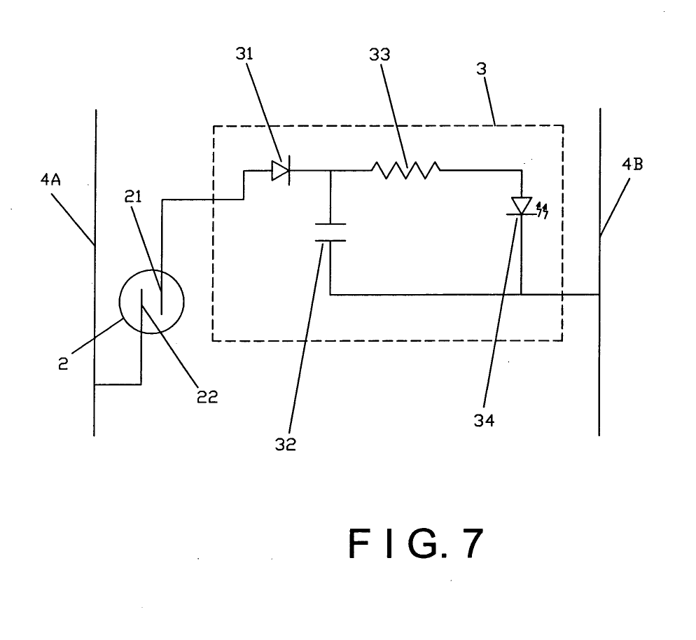

Referring to FIG. 7, which shows a circuit able to produce a specific signal when an electric current passes therethrough, for instance, an optical signal circuit (3), comprising a diode (31), a capacitor (32), an electrical resistor (33) and a light-emitting diode (34). One end of the optical signal circuit (3) is connected to the first electrode (21) of the magnetic reed switch (2), and the second electrode (22) of the magnetic reed switch (2) is connected to a live wire (4A) of a power supply circuit, and another end of the optical signal circuit (3) is connected to a neutral wire (4B) of the power supply circuit. Current direction in the live wire (4A) of the power supply circuit is opposite to that in the neutral wire (4B) of the power supply circuit. A magnetic field produced when the electric current passes through the live wire (4A) causes the first electrode (21) and the second electrode (22) of the magnetic reed switch (2) to respond to the magnetism and make contact, at which time, the electric current passes through the diode (31) and is rectified to enable a stable input current, whereupon the capacitor (32) implements filtering of the rectified electric current to decrease current noise in the electric current, and the electrical resistor (33) reduces current pressure drop, thus causing the light-emitting diode (34) to emit an optical signal, thereby indicating that an electric current has passed through the aforementioned power supply circuit or current load of the power supply circuit has already reached a certain value. If the electric current passing through the aforementioned live wire (4A) is reduced, then strength of the magnetic field produced is insufficient to cause the first electrode (21) and the second electrode (22) to respond to the magnetism and make contact, thus the optical signal circuit (3) stops functioning, and no optical signal is displayed, or the electric current stops flowing through the live wire (4A), then the first electrode (21) and the second electrode (22) will no longer make contact due to the magnetic field dieing out, thus, the optical signal circuit (3) also stops functioning, and no optical signal is displayed.

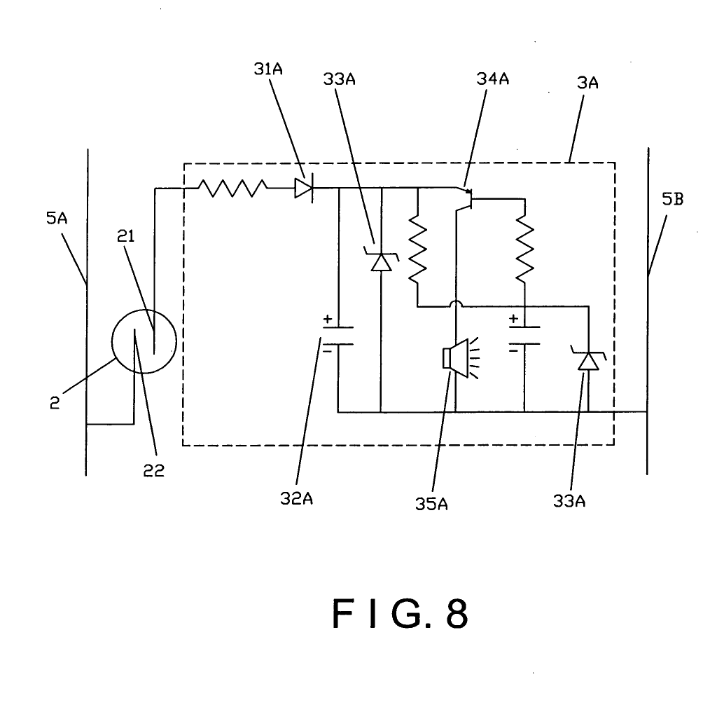

Referring to FIG. 8, which shows a circuit able to produce a specific signal when an electric current passes therethrough, for instance, a sound signal circuit (3A), comprising a diode (31A), a capacitor (32A), a zener diode (33A), a transistor (34A) and a buzzer (35A. One end of the sound signal circuit (3A) is connected to the first electrode (21) of the magnetic reed switch (2), and the second electrode (22) of the magnetic reed switch (2) is connected to a live wire (5A) of a power supply circuit, and another end of the sound signal circuit (3A) is connected to a neutral wire (5B) of the power supply circuit. Current direction in the live wire (5A) of the power supply circuit is opposite to that in the neutral wire (5B) of the power supply circuit. A magnetic field produced when the electric current passes through live wire (5A) causes the first electrode (21) and the second electrode (22) of the magnetic reed switch (2) to respond to the magnetism and make contact, at which time the electric current passes through the diode (31A) and is rectified to enable a stable input current, whereupon the capacitor (32A) implements filtering of the rectified current to decrease current noise in the electric current, and the zener diode (33A) implements current limiting on the electric current. The electric current then activates the transistor (34A), at which time the buzzer (35A) is actuated by the transistor (34A) and emits a sound signal, thereby revealing that the electric current has passed through the aforementioned power supply circuit or current load of the power supply circuit has already reached a certain value. If the electric current passing through the aforementioned live wire (5A) is reduced, then strength of the magnetic field produced is insufficient to cause the first electrode (21) and the second electrode (22) to respond to the magnetism and make contact, thereby causing the sound signal circuit (3A) to stop functioning, and no sound is emitted, or the electric current stops flowing through the live wire (5A), then, the first electrode (21) and the second electrode (22) are no longer able to make contact due to the magnetic field dieing out, thereby causing the sound signal circuit to stop functioning, and no sound signal is emitted.

Furthermore, the method using a current to control a switch of the present invention can be combined with other specific signal circuits and produce other specific signals, including:

1. Packet signals transmitted by a computer local area network or the Internet.

2. Signals conforming to wireless communications protocol, including GSM (Global System for Mobile Communications), Bluetooth, Wi-Fi (Wireless Fidelity), Wi-Max (Worldwide Interoperability for Microwave Access), and so on.

3. Signals transmitted by a wired communications network, for instance, digital signals transmitted using a telephone line.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A method using a current to control a switch, using a switch, comprising a first electrode and a second electrode, positioned within the magnetic range of a magnetic field produced by an electric current passing through a path, whereupon at least either the first electrode or the second electrode responds to the magnetism due to magnetic field variation, whereat the first electrode and the second electrode come in mutual contact or separate by means of the magnetic variation, thereby enabling controlling the switch.

2. The method using a current to control a switch according to claim 1, wherein the path is positioned to one side of the locality of the first electrode and the second electrode.

3. The method using a current to control a switch according to claim 1, wherein the path partially surrounds the locality of the first electrode and the second electrode.

4. The method using a current to control a switch according to claim 1, wherein the path encircles the locality of the first electrode and the second electrode, and encircling loops of the encircling section comprise at least one non-contacting encircling loop.

5. The method using a current to control a switch according to claim 1, wherein the path comprises two paths respectively positioned at two sides of the locality of the first electrode and the second electrode, and direction of the electric current flowing in one of the side paths is opposite to that flowing in the other side path.

6. The method using a current to control a switch according to claim 1, wherein the switch controlled by an electric current is further connected to a signal circuit able to produce a specific signal, and uses passing of an electric current to cause the specific signal circuit to produce a specific signal.

7. The method using a current to control a switch according to claim 6, wherein the specific signal circuit is an optical signal circuit.

8. The method using a current to control a switch according to claim 7, wherein an electric current passes through a rectifying diode, then a capacitor implements filtering of the rectified electric current, and an electrical resistor reduces current pressure drop, thus causing a light-emitting diode to emit an optical signal.

9. The method using a current to control a switch according to claim 6, wherein the specific signal circuit is an optical signal circuit.

10. The method using a current to control a switch according to claim 9, wherein an electric current passes through a rectifying diode, then a capacitor implements filtering of the rectified electric current, and a zener diode implements current filtering on the electric current, the electric current then activates a transistor, at which time a buzzer is actuated by the transistor and emits a sound signal.

11. The method using a current to control a switch according to claim 6, wherein the specific signal is a packet signal transmitted by a computer network.

12. The method using a current to control a switch according to claim 6, wherein the specific signal is a signal conforming to wireless communications protocol.

13. The method using a current to control a switch according to claim 6, wherein the specific signal is a signal transmitted by a wired communications network.
